(19) United States
(12) Patent Application Publication
(10) Pub. No.: US 2022/0110480 A1
(43) Pub. Date: Apr. 14, 2022

(54) MULTI-USE COOKING APPARATUS

(71) Applicant: Marc CARDINALI, Waterdown (CA)

(72) Inventor: Marc CARDINALI, Waterdown (CA)

(21) Appl. No.: 17/561,873

(22) Filed: Dec. 24, 2021

Related U.S. Application Data
(63) Continuation-in-part of application No. PCT/CA2020/050883, filed on Jun. 25, 2020.
(60) Provisional application No. 62/866,145, filed on Jun. 25, 2019.

(51) Int. Cl. A47J 37/07; F24B 5/06; F24B 13/02; A23B 4/052

(52) U.S. Cl. CPC A47J 37/0704; F24B 5/06; A23V 2002/00; A47J 37/0786; A23B 4/052; F24B 13/02

(57) ABSTRACT

Apparatus comprising: a body defining: a cooking chamber; a lateral vent extending horizontally from the cooking chamber; and an anterior vent extending vertically from the cooking chamber; a firebox disposed in lateral relation to the cooking chamber; a breather adapted, when in communication with the atmosphere, to provide for fluid communication between the atmosphere and the cooking chamber; a fire tray having an operative position in the cooking chamber above the breather; and a valve arrangement operatively disposed between the firebox and atmosphere, the firebox and the cooking chamber, the breather and the atmosphere, the anterior vent and the atmosphere and the lateral vent and the atmosphere and having an offset smoking configuration which provides, when the firebox is in receipt of a fire, for fluid communication between the atmosphere, the firebox, the cooking chamber, the lateral vent and the atmosphere, to define an offset smoker; and a grilling configuration which provides, when the firetray is in receipt of a charcoal fire, for fluid communication between atmosphere, the breather, the cooking chamber and the atmosphere, to define a charcoal grill.

### CROSS-REFERENCE TO RELATED APPLICATIONS

This application is a continuation-in-part of PCT/CA2020/050883 filed Jun. 25, 2020, which claimed priority to United States Provisional Patent Application Serial No. 62/866,145 filed Jun. 25, 2019.

### FIELD

The invention relates to the field of cooking.

### BACKGROUND

Popular styles of outdoor cooking include grilling, smoking and baking. This typically involves dedicated grilling, smoking and baking equipment, respectively.

### SUMMARY OF THE INVENTION

Forming one aspect of the invention is apparatus comprising a body, a firebox, a breather, a firetray and a valve arrangement.

The body defines: a cooking chamber; a lateral vent extending horizontally from the cooking chamber; and an anterior vent extending vertically from the cooking chamber.

The firebox disposed in lateral relation to the cooking chamber.

The breather is adapted, when in communication with the atmosphere, to provide for fluid communication between the atmosphere and the cooking chamber.

The fire tray has an operative position in the cooking chamber above the breather.

The valve arrangement is operatively disposed between the firebox and atmosphere, the firebox and the cooking chamber, the breather and the atmosphere, the anterior vent and the atmosphere and the lateral vent and the atmosphere and has:
an offset smoking configuration which provides, when the firebox is in receipt of a fire, for fluid communication between the atmosphere, the firebox, the cooking chamber, the lateral vent and the atmosphere, to define an offset smoker; and
a grilling configuration which provides, when the firetray is in receipt of a charcoal fire, for fluid communication between atmosphere, the breather, the cooking chamber and the atmosphere, to define a charcoal grill.

Forming another aspect of the invention is apparatus comprising:
a body
   adapted for use between a cooking grid and a cooking fire
   defining, in use, a plurality of cavities, each cavity being adapted to receive water; and
   defining, in use, a plurality of passages that allow air to pass through the body, the ends of the passages being defined by apertures, the apertures being offset such that gases cannot flow directly vertically through the body.

Forming yet another aspect of the invention is apparatus for use with a plurality of fire bricks, the apparatus comprising:
a body: adapted for use between a cooking grid and a cooking fire; defining, in use, a plurality of cavities, each cavity being adapted to receive water; or one of the fire bricks; and defining, in use, a plurality of passages that allow air to pass through the body, the ends of the passages being defined by apertures, the apertures being offset such that gases cannot flow directly vertically through the body.

Forming yet another aspect of the invention is an improved cooking apparatus of the type which has a combustion area and, in use, produces ash, the improvement comprising:
an elongate open container at the base of and communicating with the combustion area;
a perforated tube that is disposed interiorly of the container; and
a breather valve adapted to selectively allow the tube to communicate with atmosphere.

According to another aspect, this apparatus can further comprise a drain valve and the container can have defined therein a drain which communicates with the drain valve such that the container can be selectively drained.
Forming yet another aspect of the invention is apparatus comprising:
a body defining: a cooking chamber; a lateral vent extending horizontally from the cooking chamber; and an anterior vent extending vertically from the cooking chamber;
a firebox disposed in lateral relation to the cooking chamber;
a breather adapted, when in communication with the atmosphere, to provide for fluid communication between the atmosphere and the cooking chamber;
a fire tray having an operative position in the cooking chamber above the breather; and
a valve arrangement operatively disposed between the firebox and atmosphere, the firebox and the cooking chamber, the breather and the atmosphere, the anterior vent and the atmosphere and the lateral vent and the atmosphere and having
   an offset smoking configuration which provides, when the firebox is in receipt of a fire, for fluid communication between the atmosphere, the firebox, the cooking chamber, the lateral vent and the atmosphere, to define an offset smoker; and
   an indirect smoker configuration which provides, when the firetray is in receipt of a charcoal fire, for fluid communication between atmosphere, the breather, the cooking chamber, the anterior vent and the atmosphere.

Advantages, features and characteristics of the present invention will become apparent upon review of the following detailed description with reference to the appended drawings, the latter being briefly described hereinafter.

### BRIEF DESCRIPTION OF THE DRAWINGS

FIG. 1 is a view of the components of a system according to an exemplary embodiment;

FIG. 2 is an enlarged view of the structure of encircled area A of FIG. 1;

FIG. 3 is a view of the structure of encircled areas B,C of FIG. 1 in use with the structure of encircled area A of FIG. 1;

FIG. 4A is a view of the structure of, inter alia encircled areas D,E,F and G of FIG. 1 in use with the structure of FIG. 3;

FIG. 4B is a view of the structure of, inter alia, encircled areas H,I in use with the structure of FIG. 4A;

FIG. 4C is a view of the structure of encircled areas J, K in use with the structure of FIG. 4B;

FIG. 5 is an enlarged view of the structure of encircled area F in use with the structure of encircled area D of FIG. 1;

FIG. 6 is an enlarged view of the structure of encircled area D of FIG. 1;

FIG. 7 is a top plan view of the structure of FIG. 6;

FIG. 8 is a view along 8-8 of FIG. 7;

FIG. 9A is a view of the structure of encircled areas D and L of FIG. 1 in use with the structure of encircled area C of FIG. 1, in a lowered position;

FIG. 9B is a view of the structure of FIG. 9A, in a raised position;

FIG. 10A is a view of the structure of FIG. 9A in use with the structure of encircled area F of FIG. 1;

FIG. 10B is a view of the structure of FIG. 10A, in a raised position;

FIG. 11 is a cross-sectional view of the structure of encircled area A of FIG. 1, with all components of the valve arrangement closed;

FIG. 12 is a view similar to FIG. 11 with all components of the valve arrangement open;

FIG. 13 is a view of the structure of encircled areas A, H, I of FIG. 1 in use in an offset smoking configuration;

FIG. 14 is an end view of the structure of FIG. 13 with internal structures shown in phantom;

FIG. 15 is a view along 15-15 of FIG. 13;

FIG. 16 is a view of the structure of encircled areas A, B,C, H, I in use in a grilling configuration;

FIG. 17 is along 17-17 of FIG. 16;

FIG. 18 is a view of the structure of FIG. 16 in use in another grilling configuration;

FIG. 19 is a view of the structure of FIG. 16 and encircled areas D, F and L of FIG. 1 in use in another grilling configuration;

FIG. 20 is a view of the structure of FIG. 18 and encircled areas D, E,L and M of FIG. 1 in use in an indirect smoking configuration;

FIG. 21 is a view of the structure of encircled areas A-H, J-N, P and Q in use in a deck oven configuration;

FIG. 22 is a view along 22-22 of FIG. 21;

FIG. 23 is a detail view of encircled area 23 of FIG. 22;

FIG. 24 is a view of the structure of encircled areas A-G and J-N of FIG. 1 in use in a wood fired pizza oven configuration;

FIG. 25 is a view of the structures of encircled areas A-G and J-N of FIG. 1 in use in a wood fired roasting oven configuration;

FIG. 26 is a view along 26-26 of FIG. 25;

FIG. 27 is a view of the structure of encircled areas A-G and J-N in another configuration;

FIG. 28 is a view showing another embodiment of the structure of FIG. 5;

FIG. 29 is a view of the structure of FIG. 28 with the bricks removed as in FIG. 6;

FIG. 30 is a view along section 30-30 of FIG. 29; and

FIG. 31 is a view of encircled area 31 of FIG. 30.

### DETAILED DESCRIPTION

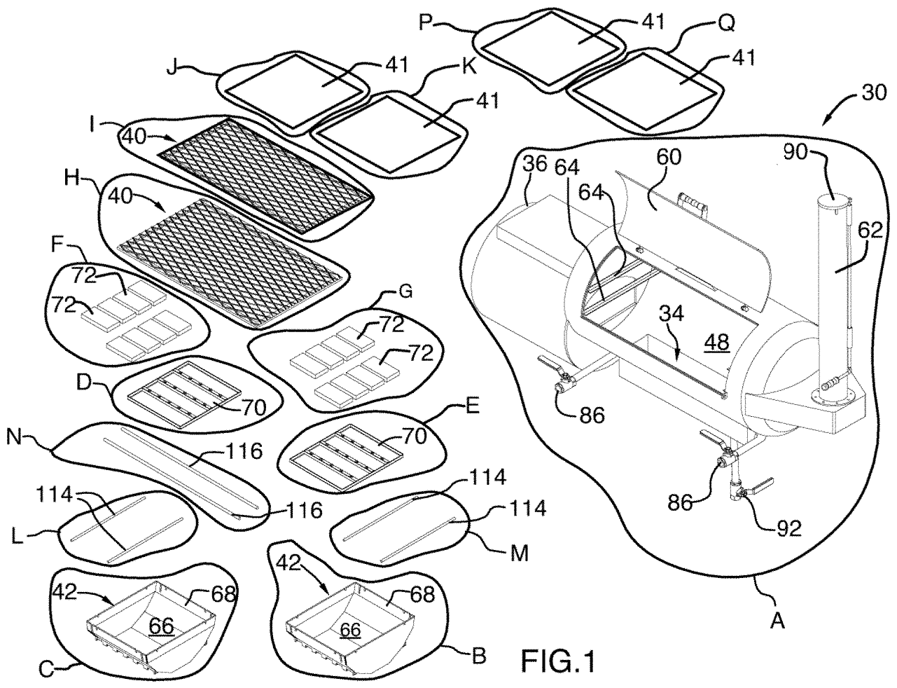

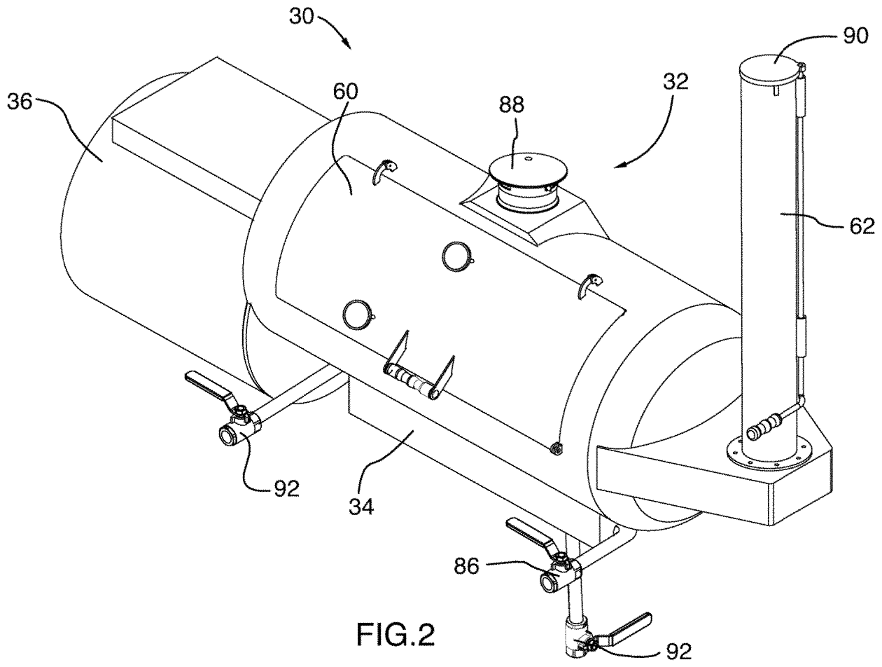

With reference to FIGS. 1, 2 and 11, the system 30 will be seen to comprise a body 32, a trough 34, a firebox 36, a breather 38, a pair of grates 40, pizza stones 41, a pair of fire trays 42, a pair of flame shields 70, a plurality of fire bricks 72, a valve arrangement 46, elevation rods 114 and spacer rods 116.

The body defines a drum-shaped cooking chamber 48 having a base 50 and a pair of ends 52,54, a lateral vent 56 extending horizontally from the cooking chamber and an anterior vent 58 extending vertically from the cooking chamber and includes a hinged door 60 to provide access to the cooking chamber, a water container 61 disposed interiorly of the cooking chamber, a smoke stack 62 to which the lateral vent extends and, at each end, a pair of rails 64.

The trough 34 is an open container disposed at the base of the cooking chamber 48 and communicates therewith.

The firebox 36 is disposed in lateral relation to the cooking chamber 48, opposite the smokestack 62.

The breather 38 is a perforated tube disposed within the trough 34.

The firetrays 42 each have an arcuate bottom surface 66 formed of perforated metal (not shown) that has substantially the same diameter as the cooking chamber 48 and an open upper end defined by a frame 68. The frame has lateral notches 118, shallow notches 120 and deep notches 122.

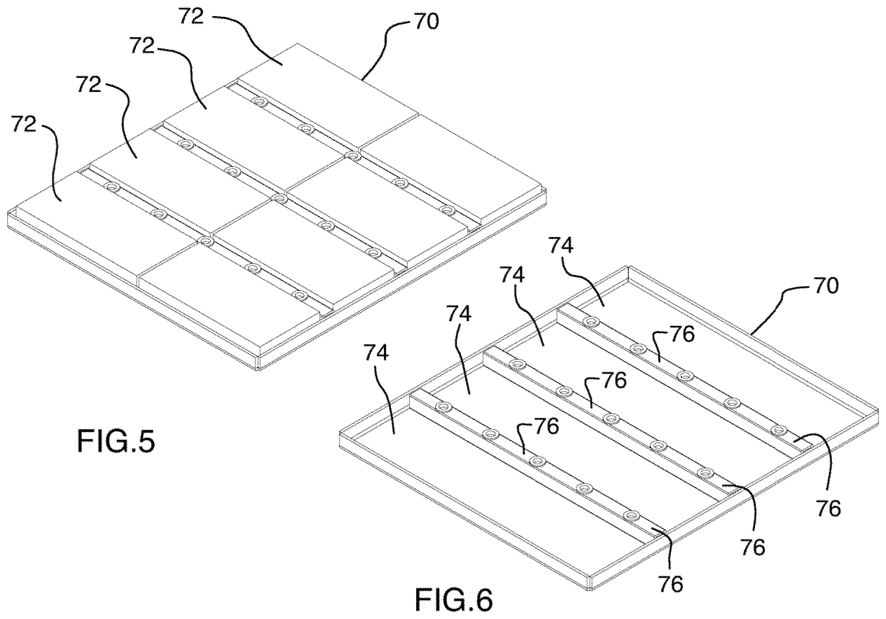

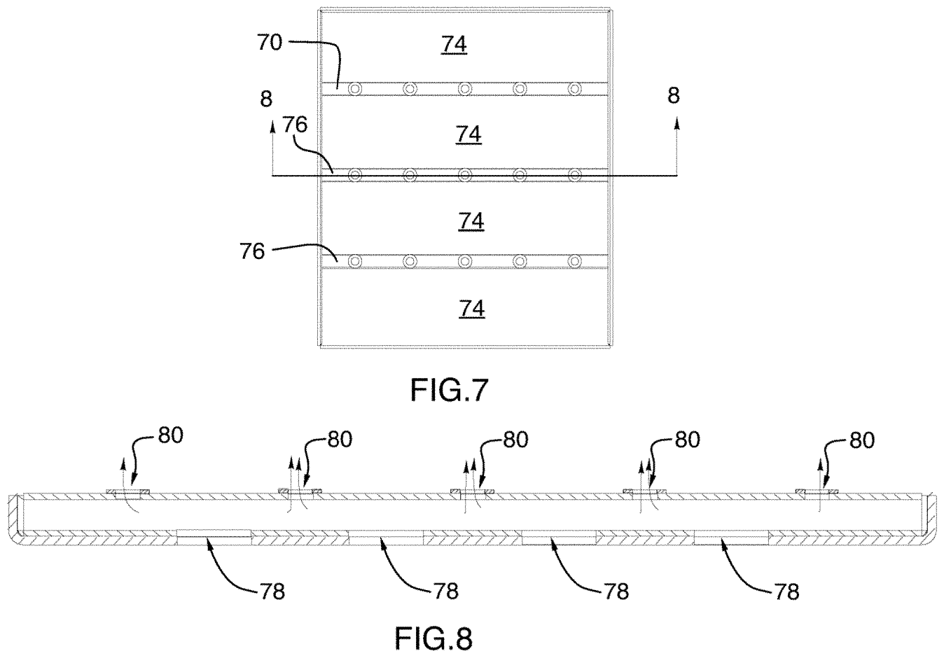

The flame shields 70 each have an outer perimeter that is substantially the same shape as the frame and define, as seen in FIGS. 5-8: a plurality of cavities 74 separated by a plurality of tubular elements 76, the tubular elements having a plurality of apertures 78, 80 arranged in offset relation to one another.

The elevation rods 114 are about the depth of the cooking chamber 48 and the spacer rods 116 are about the width of the cooking chamber 48.

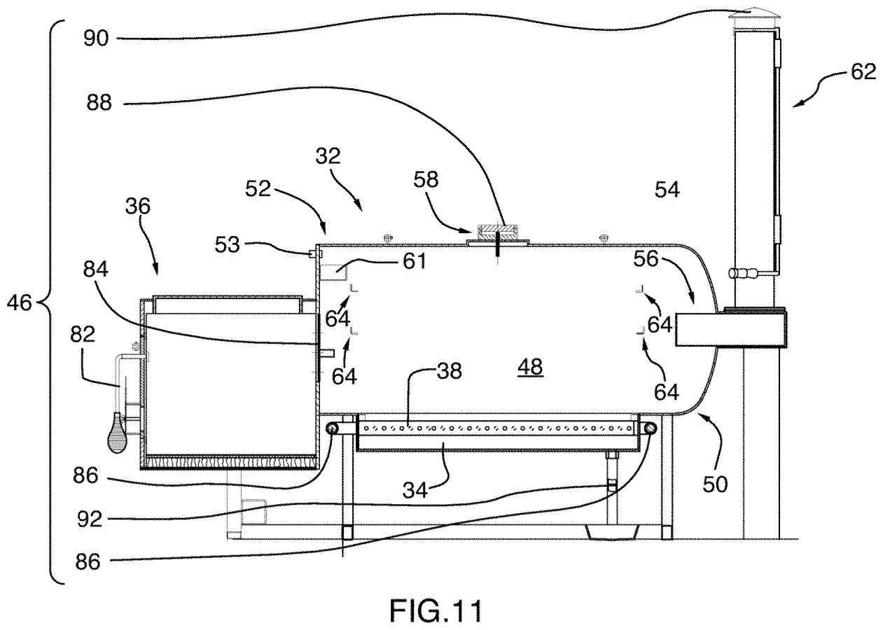

The valve arrangement comprises, as indicated in FIG. 11:
between the firebox and atmosphere, a baffle 82
between the firebox and the cooking chamber, a baffle 84,
between the breather and the atmosphere, a pair of valves 86
between the anterior vent and the atmosphere, a baffle 88 and
between the lateral vent and the atmosphere, a baffle 90; and
at the base of the trough, a drain valve 92.

### Positions/assembly

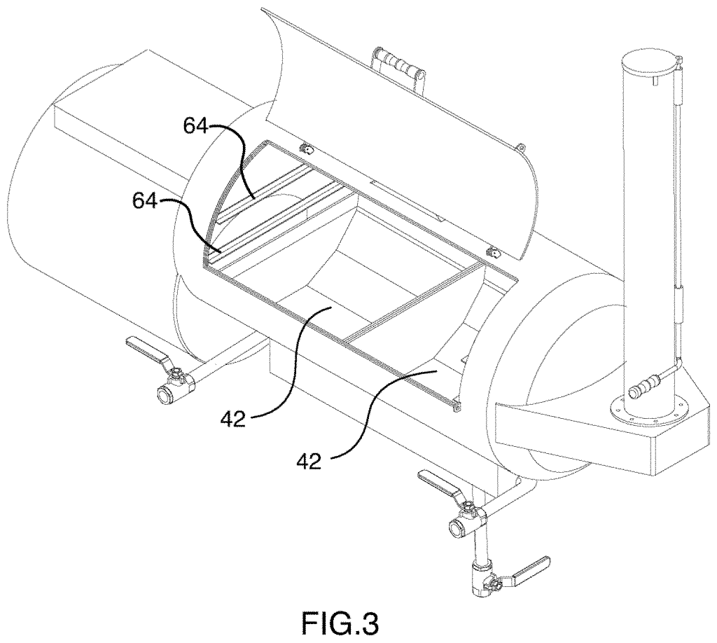

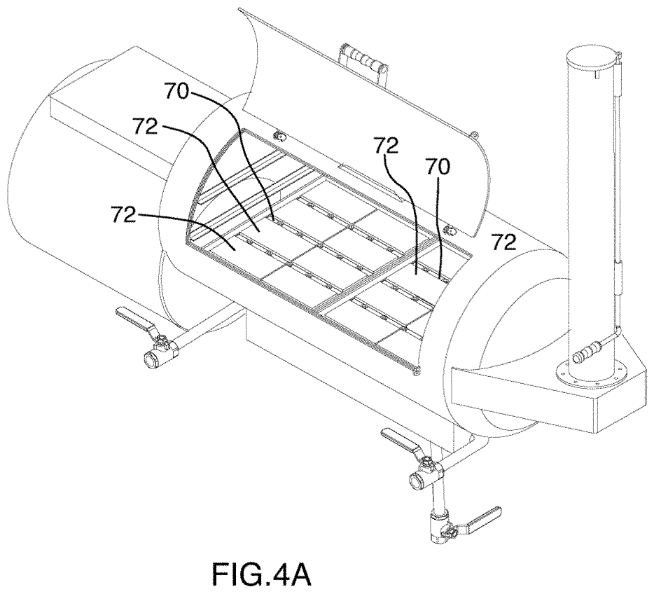

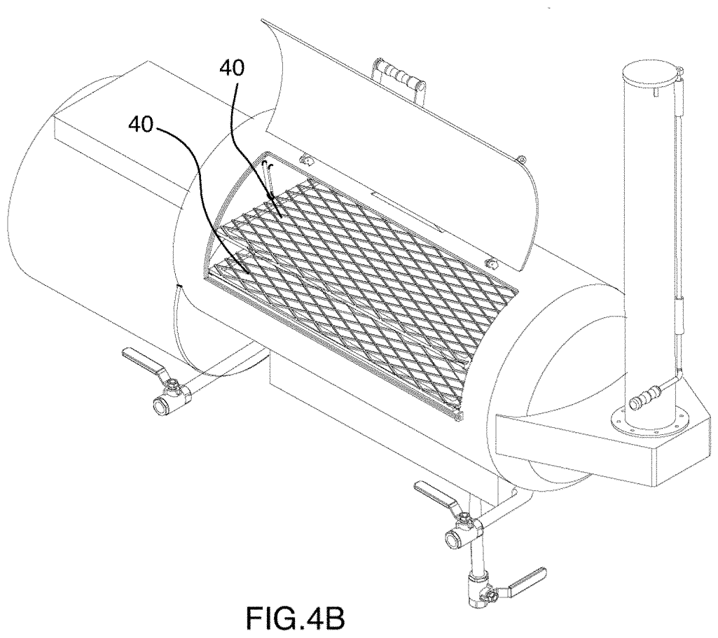

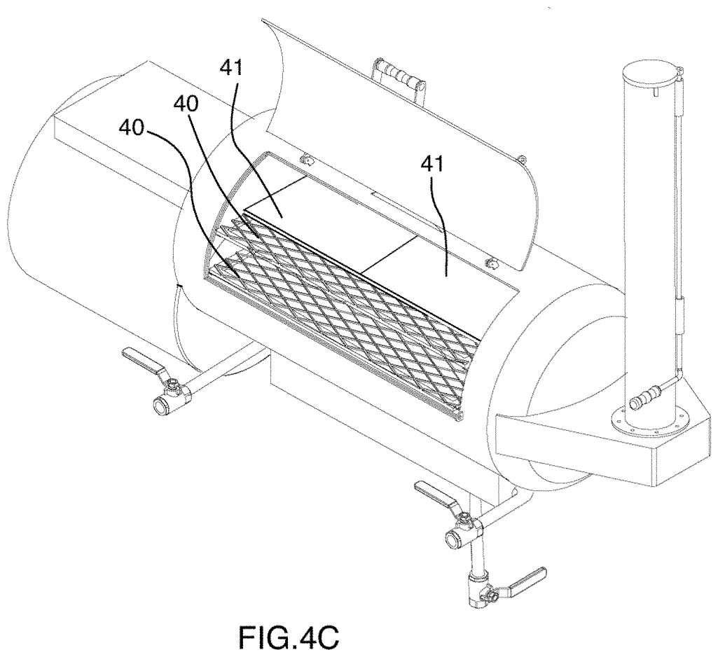

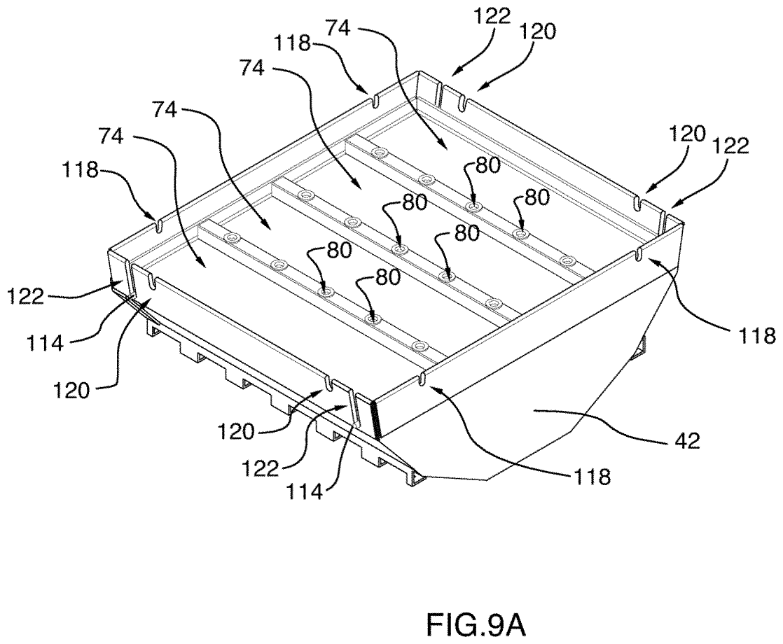

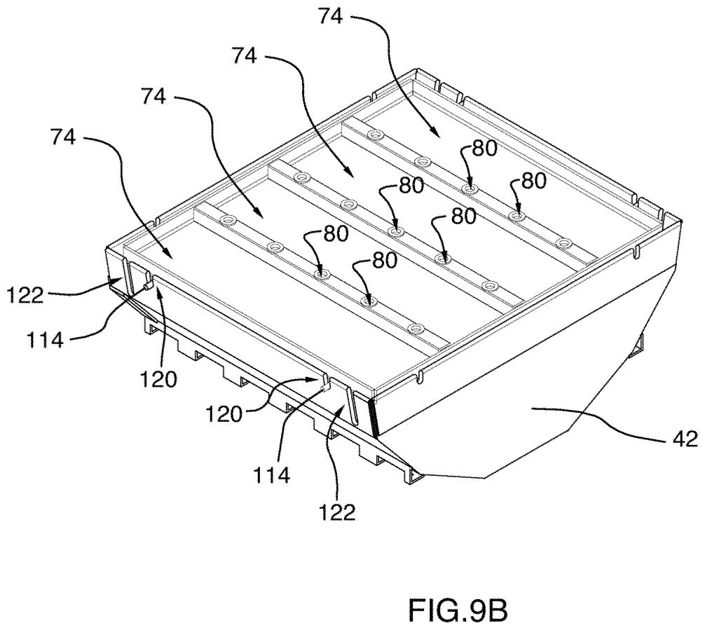

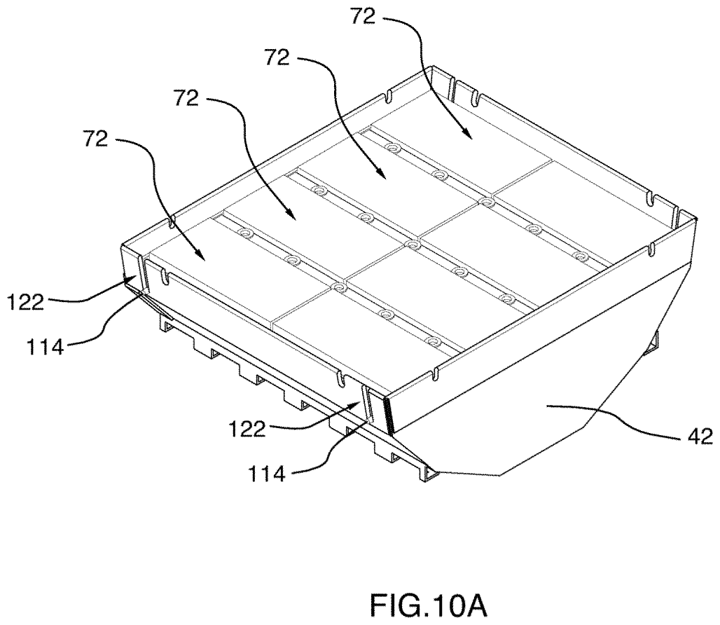

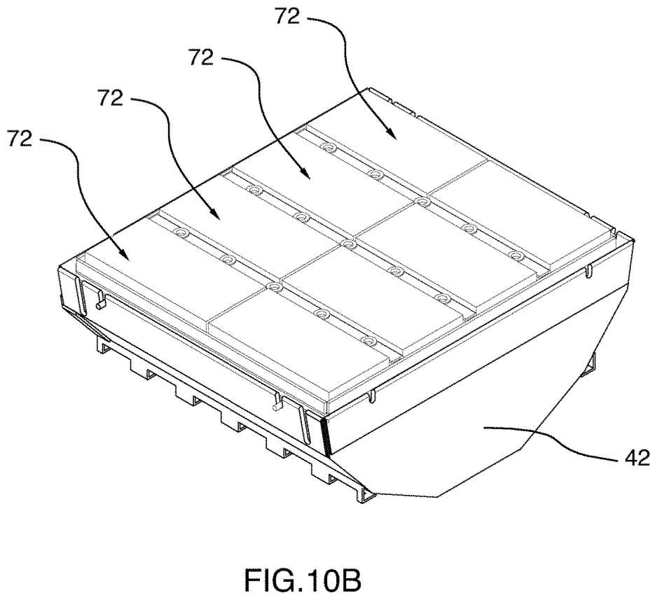

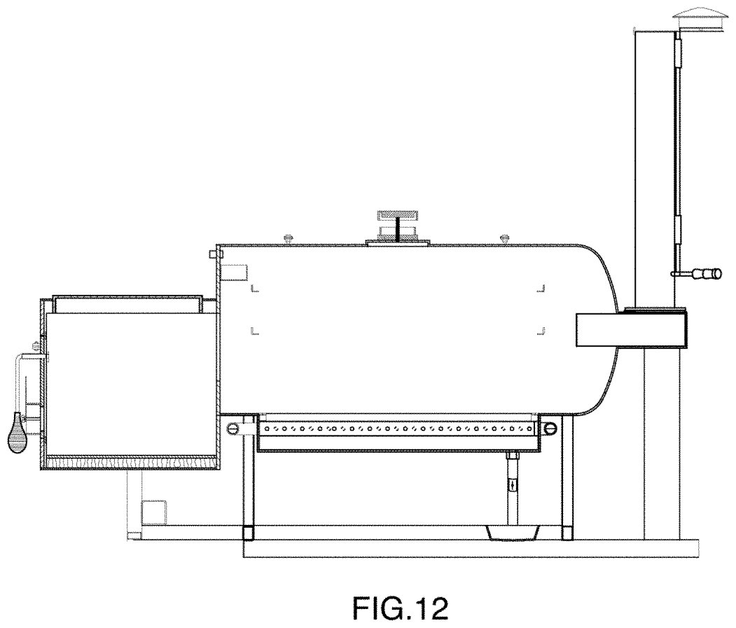

The valves and baffles will each be understood to have closed positions, as shown in FIG. 11, and open positions, as shown in FIG. 12; the fire trays will each to be understood to be positionable in the cooking chamber above the breather at a respective operating position, as shown in FIG. 3; the grates 40 will be understood to be positionable upon the rails, as shown in FIG. 4B, above the firetray; the flame shields 70 will each be understood to be positionable in the fire trays in an lowered position as shown at FIG. 9A, in which the elevation rods 114 are disposed in the deep notches 122 and the flame shields rest upon the rods 114, and an raised position 9B wherein the rods are in the shallow notches 120; the fire bricks 72 will be understood to be positionable in the cavities 74, as shown in FIG. 10A and also upon the fire trays, as shown in FIG. 10A,B.

### Configurations

The foregoing apparatus is capable of adopting the following configurations, among others.

### Offset Smoker Configuration

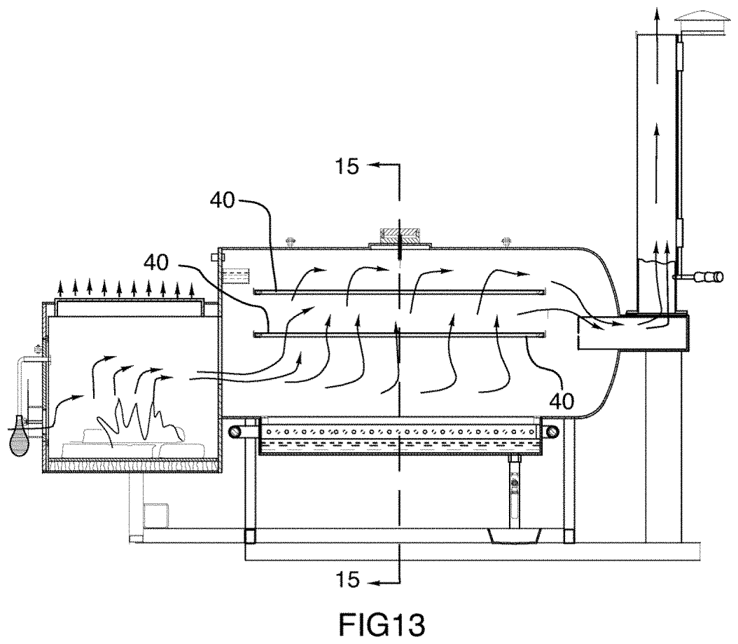

This configuration is shown in FIGS. 13-15 and it will be understood to be characterized by a firebox 36 that is in receipt of a fire, a trough 34 and container 61 in receipt of water and a configuration of the valve arrangement that provides for fluid communication between the atmosphere, the firebox, the cooking chamber, the lateral vent and the atmosphere. It will be understood that the positions of the grates 40 are such that the air flow from the firebox to atmosphere passes air through the grates, to impart smoke to the food. The water in the trough and container helps keep moisture in the food and also facilitates cleaning, since grease can accumulate in the trough and be easily rinsed away.

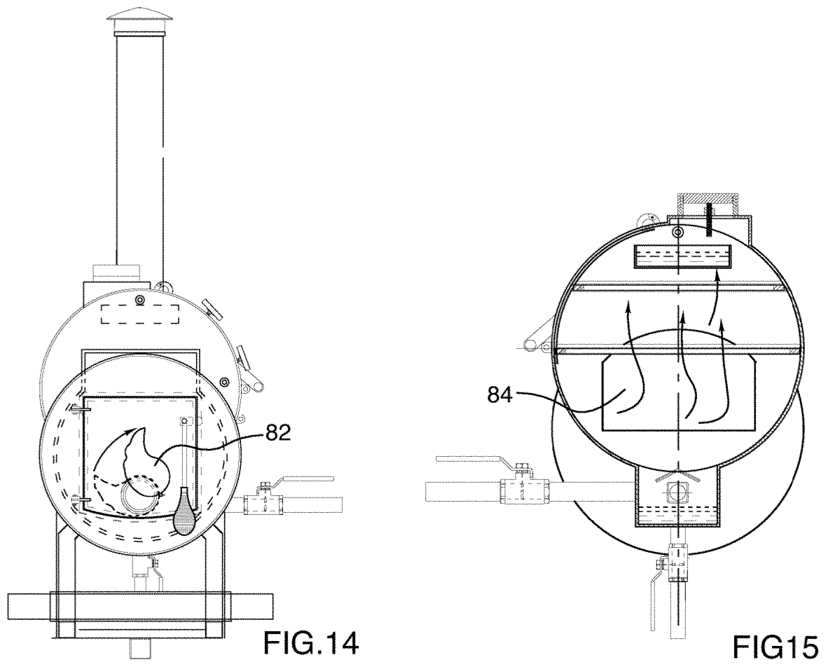

Valve 82 can be rotated as indicated in FIG. 14 to vary the amount of air entering the firebox, to control temperature. Door panel 84 can also be removed or replaced as desired; when a relatively hot fire is used, the door panel 84 will typically be installed to act as a flash blocker. Door panel 84 can be positioned in an inverted position, to partially occlude the opening, only. The offset smoker configuration avoids the combustion of fat, which has advantageous impacts upon flavor.

### Grilling Configuration

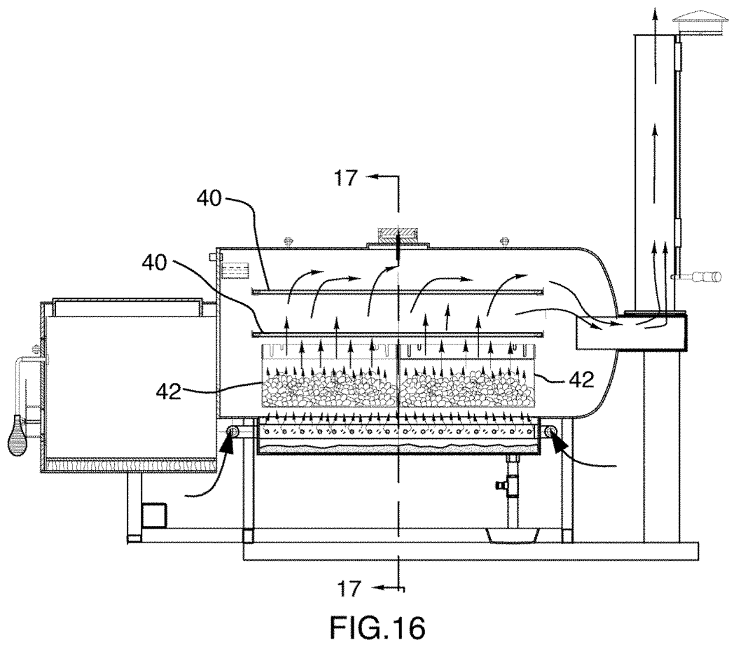

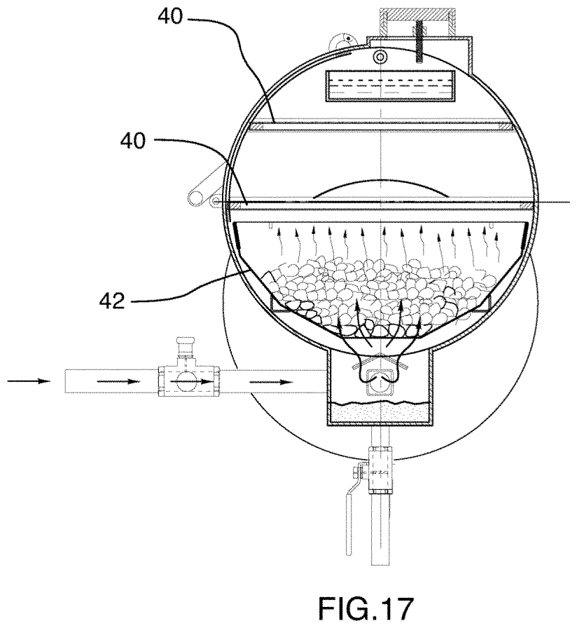

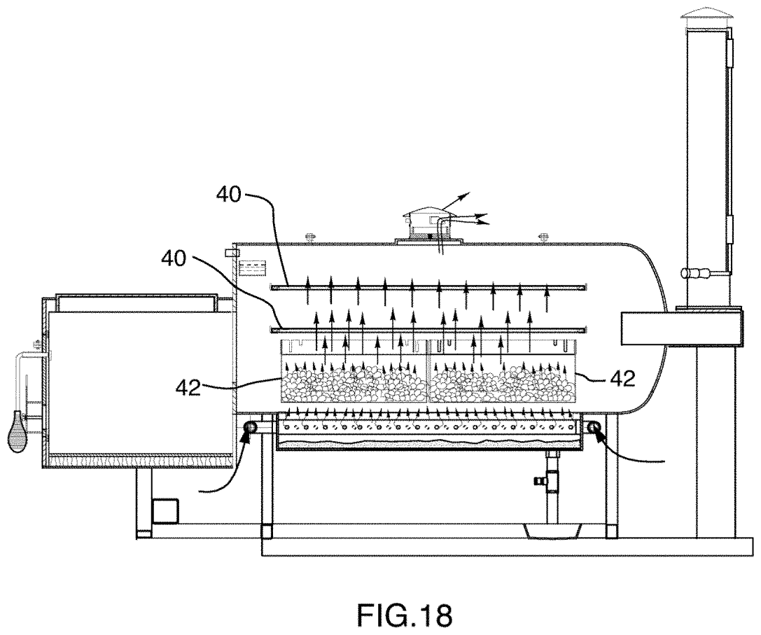

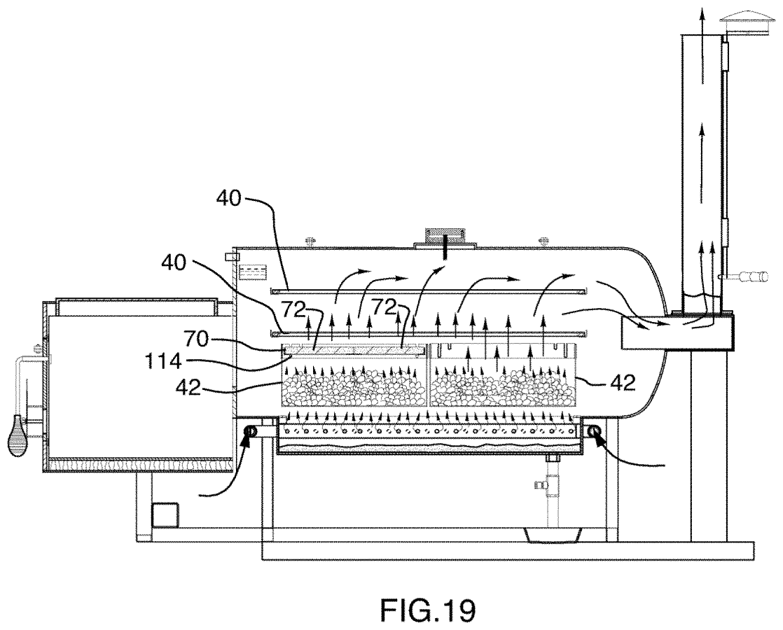

Grilling configurations are shown in FIG. 16 and will be understood to be characterized by firetrays 42 in operative positions and in receipt of a charcoal fire, grates 40 at an operative position above the firetrays, water in the container 61 and a configuration of the valve arrangement that provides for fluid communication between atmosphere, the breather 38, the cooking chamber 48 and the atmosphere. In this and all later-described configurations, the trough is used for collection of ash, which also is easily removed through the drain after use. In FIG. 16, the lateral vent is used, to add more smoke flavor; in FIG. 18, the anterior vent is used; in FIG. 19, the lateral vent is used, along with one of the fire shields, thereby to allow for flame and flameless indirect grilling.

### Indirect Smoker/Roaster Configuration

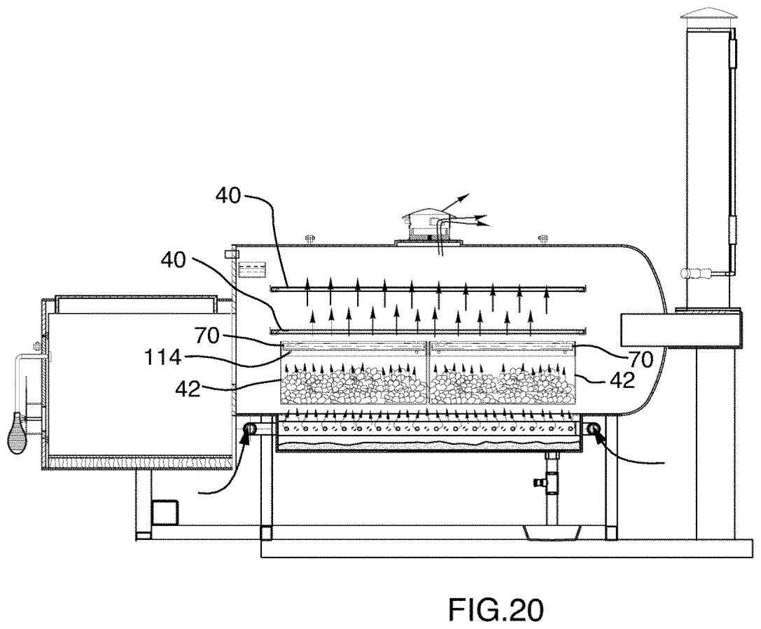

This configuration is shown in FIG. 20 and will be understood to be characterized by firetrays in receipt of fire, flame shields in the lowered positions, water in the container and cavities 74 and a configuration of the valve arrangement that provides for fluid communication between the atmosphere, the breather, the cooking chamber and the anterior vent.

### Deck Oven Configuration

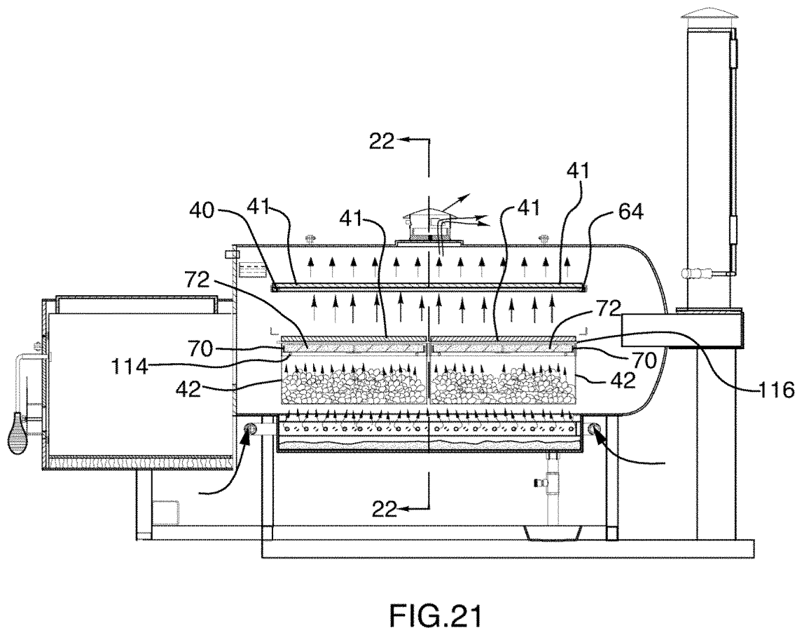

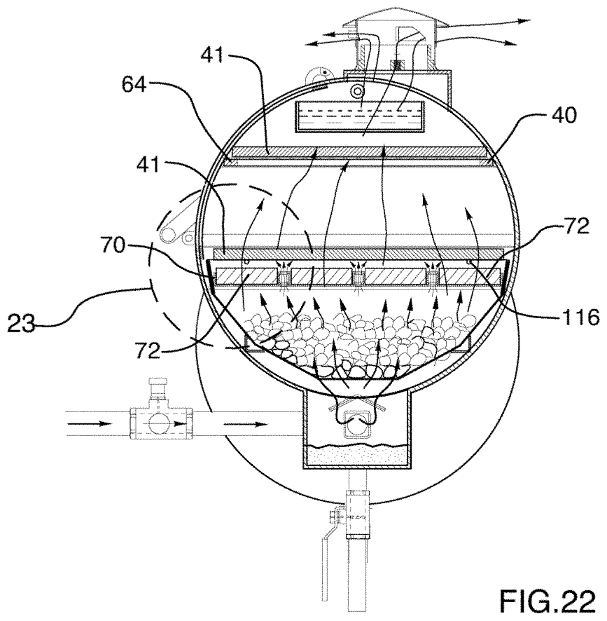

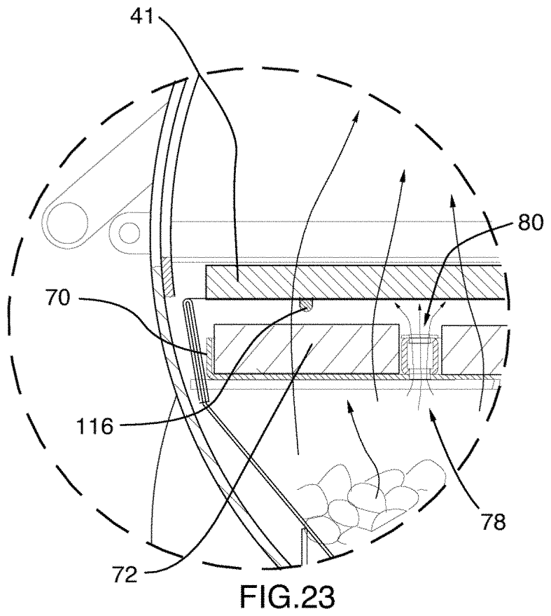

This configuration is shown in FIGS. 21-23 and will be understood to be characterized firetrays 42 in receipt of fire, flame shields 70 in the raised positions, fire bricks 72 placed upon the flame shields 70, spacer rods 116 in the lateral notches 118, pizza stones 41 placed on the rods 116 and also upon upper grill 40 , water (optionally) in the container 61 and a configuration of the valve arrangement that provides for fluid communication between the atmosphere, the breather, the cooking chamber and the anterior vent. Water in the container can be advantageous, for example, for baking breads and the like.

### Wood-Fired Pizza Oven

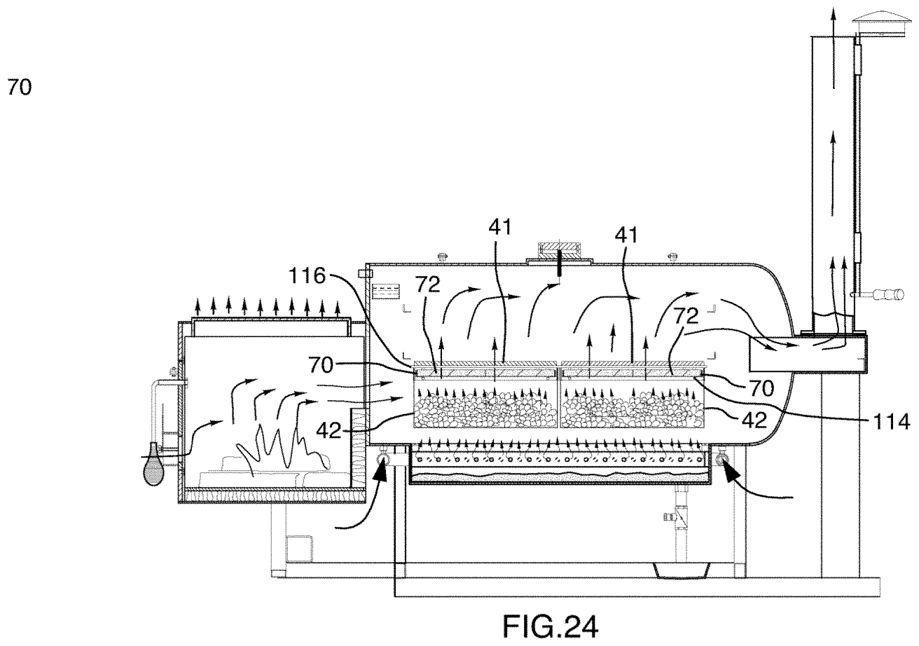

This configuration is shown in FIG. 24 and will be understood to be characterized by a firebox 36 in receipt of a wood fire, firetrays 42 in receipt of fire, flame shields 70 in raised positions, fire bricks 72 on the flame shields, pizza stones 41 on the spacer rods 116 a configuration of the valve arrangement that provides for fluid communication between: the atmosphere, the firebox 36 and the cooking chamber 48; the atmosphere, the breather 38 and the cooking chamber 48; and the cooking chamber 48 and the lateral vent 62.

### Wood Fired Roasting Oven

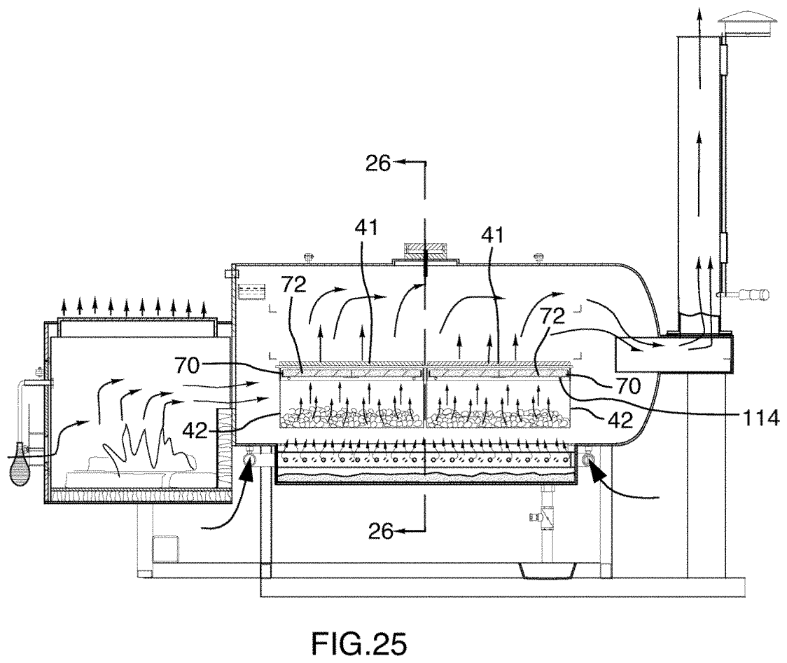

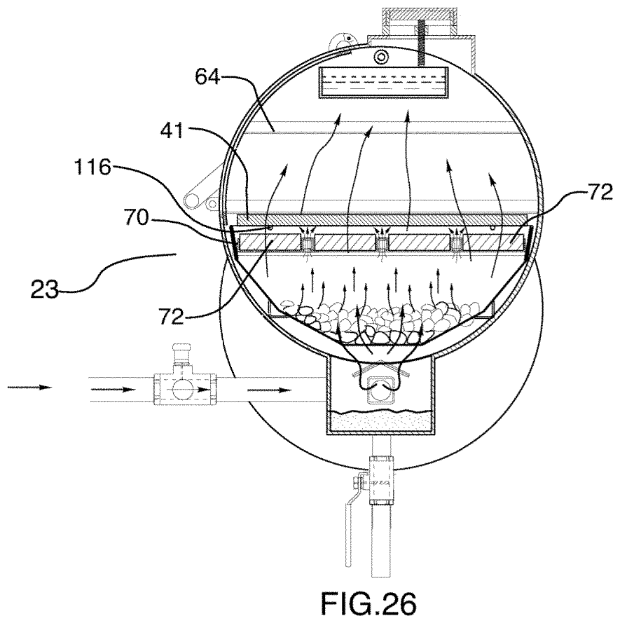

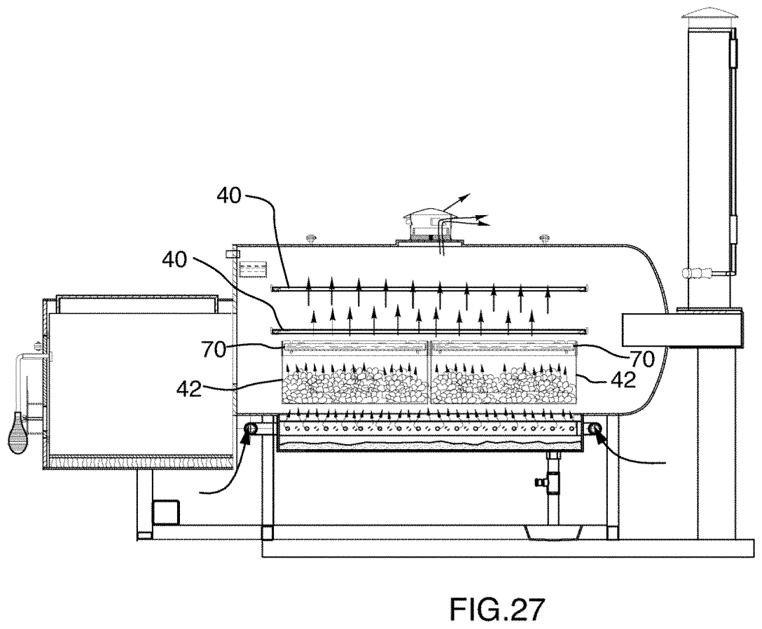

This configuration is shown in FIGS. 25-26 and will be understood to be characterized by a firebox 36 in receipt of a wood fire, firetrays 42 in receipt of fire, flame shields 70 in the lowered positons, fire bricks 72 in the flame shields, pizza stones 41 on spacer rods 116, water in container 61 and a configuration of the valve arrangement that provides for fluid communication between: the atmosphere, the firebox 36 and the cooking chamber 48; the atmosphere, the breather 38 and the cooking chamber 48; and the cooking chamber 48 and the lateral vent 62.

### Uses

The apparatus can be used in at least the following ways.

### Offset Smoking

To use the apparatus for offset smoking, the steps are as follow:
1) Remove the baffle/shield 84 through the cook chamber door.
2) Fill water trough 34 to the underside of the breather 38 and fill the hanging reservoir 61. This creates a humid environment and limits burning, offers tender results, prevents fats for burning and off gassing and easy clean up. If you run out of water you can fill externally through the valves and the access point 53 on the fire wall.
   3) Cooking grids 40 are used for low and slow barbecue and are installed in the cook chamber 48
   4) Open Chimney stack 62 at far end
   5) Start fire in firebox 36 and run fire with door open until amber coal accumulate (45 min to 1 hr)
   6) The wing damper 82 on firebox door and damper 90 on the chimney stack are used to regulate the desired cooking temperature, approx. 250F
   7) Once the target temperature has been achieved, open the cook chamber door 60 and load your meat/food onto the grids 40 and close.
   8) Watch the fire and add wood to sustain temperature, this may go on for a very long time, depends on what you are cooking
   9) When the food is done you can empty the water from trough 34 and rinse clean.

### Grill Direct Over the Coals

For direct coal grilling, the steps are as follow:
1) Install baffle/shield 84 through cook chamber and plug far end chimney stack 62
2) Place fire trays 42 in cook chamber 48 and add fuel, such as lump charcoal
3) Open chimney above the cook chamber door and install the chimney vent cap/damper 88
   4) Open valves 86 that allow the breather to offer combustion air into the cook chamber
   5) Open cook chamber door 60 and start fire in the fire trays, for example, with a torch
   6) Leave the cook chamber door open for 5 to 10 minutes to allow carbon to exit quicker
   7) Install cook grids 40 for grilling (one or both)
   8) Close the cook chamber door and stabilize grilling temperature with valves 86.
   9) Once the target temperature has been achieve, begin grilling your food.
   10) Once cooking has completed and the fires are extinguished, ash can be washed from the trough by opening valve 92.

### Deck Oven

To use the apparatus as a deck oven, the steps are as follow:
1) Close firebox with baffle/shield 84 and close/plug far end chimney/stack 62
2) Remove lower cooking grid/grill 40
3) Install fire trays 42 and load with fuel such as charcoal
4) Ensure valve 92 is closed.
5) Open valves 86 to allow breather to have combustible air enter the cook chamber and open chimney at the top of the cook chamber and install the chimney cap vent/damper
   6) Start fire in fire trays
   7) Install flame shields 70 in the upper position; place firebricks 72 upon shields 70
   8) Install the pizza stones 41 on the rails 64
   9) Once your target temperature has been achieved and stabilized, and clear smoke is exiting the chimney cap/vent damper, cook your food as you would in any indoor oven.

### Indirect Smoking (& Roasting)

To use the apparatus for indirect smoking and/or roasting, the steps are as follow:
1) Close firebox with baffle/shield 84
2) Close/plug far end chimney/stack 62
3) Fill hanging water reservoir 61
4) Install fire trays 42 and load with fuel such as charcoal
5) Close drain valve 92
6) Open valves 86 to allow breather 38 to have combustible air enter the cook chamber 48 and open chimney 58 at the top of the cook chamber and install the chimney cap vent/damper 88
7) Start fire in fire trays 42
8) Install flame shields 70;
9) Install cooking grids 40 on the rails 64
10) Stabilize your desired cooking temperature with the valves that supplies the breather with combustible air and set the chimney cap vent/damper to allow the speed of the air to exist at a rate to hold a constant temperature. (For smoking 225F-300F and for indirect roasting 325F-400F temperatures)
11) Place your food onto the cooking grids/grills and begin cooking

This set up can also be set up with a single flame shield in one “fire tray/basket”. This will allow the other side “flame tray/basket” to have a direct over the coals access for searing and crusting or charring up the proteins or vegetables.

### Wood-Fired Pizza Oven

To use the apparatus as a wood fired pizza oven, the steps are as follow:
1) Open offset firebox by removing baffle/shield 84 through cook chamber door and open lateral stack 62
2) If in place, remove hanging water reservoir, not of use for this set up
3) If in place, remove lower cooking grid/grill
4) Install fire trays 42 and load with fuel such as charcoal
5) Close drain valve 92
6) Open valves 86 to allow breather 38 to have combustible air enter the cook chamber
7) Start fires in fire trays 42 first and then start the second fire in the offset firebox with very dry wood that will offer clean burning and minimal smoke. Open the wing vent 82 on the fire box door completely and only dampen down the air flow if temperature over shooting.
8) Install flame shields 70
9) Place fire bricks in the cavities 72
10) Install the pizza stones on the grid
11) once your target temperature, such as 675F has been attained and is stable, and clear smoke is exiting the far end chimney/stack, place pizza on the baking stone closest to the fire in the firebox
12) Close the door and peek after 20 to 30 seconds and rotate the pizza and check the bottom.
13) Once browning and spotting is achieved move pizza away from the fire side area and move to lesser heat on the bottom level close to the chimney/stack and allow to brown the bottom.
14) The upper rack in this setup can be used to brown the top of the pizza if needed.

### Roasting Oven

Roasting is basically the same as wood-fired pizza cooking; just drop the target temperature (325F-450F) and cook with cookware's such as cast iron, stainless and clay pots. The baking stones are used like an induction/element and the added air & smoke from the venturi resulting from the offset fire.

### Wood-Fired Roasting Oven (Target Temp is 400F)

To use the apparatus as a wood-fired roasting oven, the steps are as follow:
1) Open firebox by removing baffle/shield 84 through cook chamber door, open lateral stack 62
2) Fill hanging water reservoir 61
3) Install fire trays 42 and load with fuel such as charcoal
4) Close drain valve 92
5) Open valves 86 to allow breather to have combustible air enter the cook chamber
6) Start fires in fire trays first and then start the second fire in the offset firebox with flavour wood that will offer minimal delicate smoke. Open the wing vent 82 to half open on the fire box door and only dampen down the air flow if temperature over shooting. The valves will also be used to damper down to restrict the air to the “breather” to aid in maintaining the desire temperature.
7) Install flame shields 70 in the lower position and fill with water ⅛″ below the tubing breathing holes. The flame shield will act as a drip pan and still allow for air & smoke to make contact with the food (from the fire below). This feature offers a moist radiant heat from below the food.
8) Install the cooking grids/grills 40 lower and upper if desired.
9) Once your target temperature, such as 400F is achieved and has stabilized, you are looking for delicate aromatic smoke exiting the far end chimney/stack with the damper in use to help control temperature, approximately % open works well.
10) Place your food on the cooking grid/grill close the cook chamber door and periodically check you food and cook until desired doneness.

The Wood-Fired Roasting Oven set up can also be set up with a single flame shield in one fire tray. This will allow the other side fire basket to have a direct over the coals access for searing and crusting or charring up the proteins or vegetables.

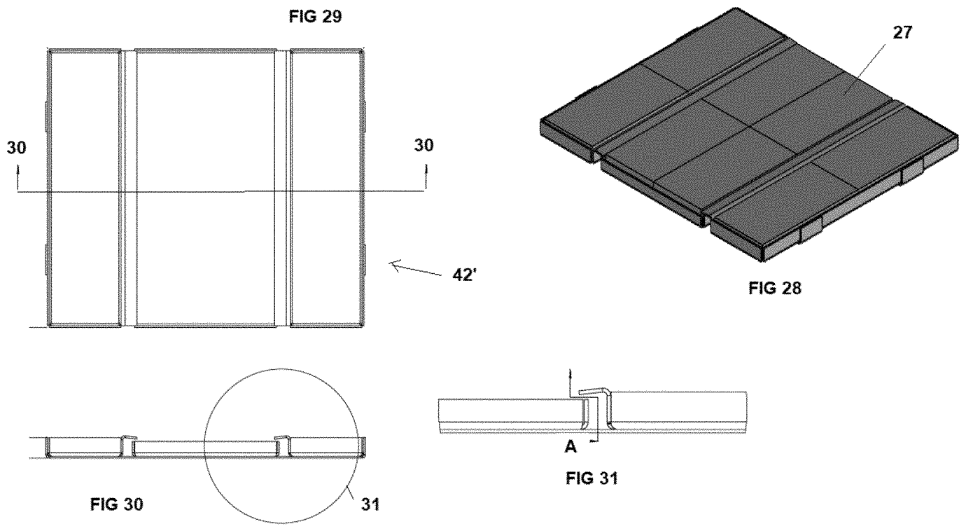

### Variations

Whereas a specific embodiment of the apparatus is illustrated above, it will be evident that variations are possible. One such variation is shown in the variant of the structure of FIG. 6 shown in FIG. 28 and indicated as 42′. This structure works substantially similar to that of FIG. 6, i.e. airflow passes therethrough along path A, and it can contain firebricks 27, but is of simpler manufacture. It should be understood that structures of the type shown in FIGS. 5,6, 28, 29 can be used, not only in the present invention, but with prior art grills and barbeques. As yet a further example, whereas two fire trays are shown, it will be evident that greater or lesser number of fire trays could be provided. Similarly, whereas a pair of grates are provided for each fire tray, greater or lesser numbers of grates could be provided for each fire tray. Yet further variations are possible. Accordingly, the invention should be understood to be limited only by the accompanying claims, purposively construed.

1. Apparatus comprising:
a body defining: a cooking chamber; a lateral vent extending horizontally from the cooking chamber; and an anterior vent extending vertically from the cooking chamber;
a firebox disposed in lateral relation to the cooking chamber;
a breather adapted, when in communication with the atmosphere, to provide for fluid communication between the atmosphere and the cooking chamber;
a fire tray having an operative position in the cooking chamber above the breather; and
a valve arrangement operatively disposed between the firebox and atmosphere, the firebox and the cooking chamber, the breather and the atmosphere, the anterior vent and the atmosphere and the lateral vent and the atmosphere and having
an offset smoking configuration which provides, when the firebox is in receipt of a fire, for fluid communication between the atmosphere, the firebox, the cooking chamber, the lateral vent and the atmosphere, to define an offset smoker; and
a grilling configuration which provides, when the firetray is in receipt of a charcoal fire, for fluid communication between atmosphere, the breather, the cooking chamber and the atmosphere, to define a charcoal grill.

2. Apparatus according to claim 1, further comprising a flame shield that has a lowered position in the cooking chamber that is relatively proximal to the breather and a raised position in the cooking chamber that is relatively distal to the breather.

3. Apparatus according to claim 2, wherein the valve arrangement has a vertical configuration which provides, when the firetray is in receipt of a fire, for fluid communication between the atmosphere, the breather, the cooking chamber and the anterior vent, to define:
when the flame shield is in the raised position, a deck oven;
when the flame shield is in the lowered position, an indirect smoker.

4. Apparatus according to claim 2, wherein the valve arrangement has a combination configuration which provides, when the firebox is in receipt of a wood fire and the firetray is in receipt of a fire, for fluid communication between:
the atmosphere, the firebox and the cooking chamber;
the atmosphere, the breather and the cooking chamber; and
the cooking chamber and the lateral vent,
thereby to define
when the flame shield is in the raised position, a wood fired pizza oven.

5. Apparatus according to claim 4 wherein, when the valve arrangement is in the combination configuration and the flame shield is in the lowered position, the apparatus defines a wood fired roasting oven.

6. Apparatus according to claim 1, wherein the breather is a perforated tube that traverses a trough formed at the base of the body.

7. Apparatus according to claim 4, wherein the trough has a drain valve.

8. Apparatus according to claim 1, further comprising a grate having an operative position in the cooking chamber, the operating position being such that,
when the valve arrangement is in the offset smoking configuration and the grate is at the operative position, the air flow from the firebox to atmosphere passes air through the grate; and
when the firetray is in the operative position and the grate is at the operative position, the grate is above the firetray.

9. Apparatus comprising:
a body defining: a cooking chamber; a lateral vent extending horizontally from the cooking chamber; and an anterior vent extending vertically from the cooking chamber;
a firebox disposed in lateral relation to the cooking chamber;
a breather adapted, when in communication with the atmosphere, to provide for fluid communication between the atmosphere and the cooking chamber;
a fire tray having an operative position in the cooking chamber above the breather; and
a valve arrangement operatively disposed between the firebox and atmosphere, the firebox and the cooking chamber, the breather and the atmosphere, the anterior vent and the atmosphere and the lateral vent and the atmosphere and having
an offset smoking configuration which provides, when the firebox is in receipt of a fire, for fluid communication between the atmosphere, the firebox, the cooking chamber, the lateral vent and the atmosphere, to define an offset smoker; and
an indirect smoker configuration which provides, when the firetray is in receipt of a charcoal fire, for fluid communication between atmosphere, the breather, the cooking chamber, the anterior vent and the atmosphere.

10. Apparatus comprising:
a body
adapted for use between a cooking grid and a cooking fire
defining, in use, a plurality of cavities, each cavity being adapted to receive water; and
defining, in use, a plurality of passages that allow air to pass through the body, the ends of the passages being defined by apertures, the apertures being offset such that gases cannot flow directly vertically through the body.
